(19) United States
(12) Patent Application Publication
(10) Pub. No.: US 2018/0273074 A1
(43) Pub. Date: Sep. 27, 2018

(54) SHOPPING CART ATTACHMENT

(71) Applicants: Crystal Tamez, Rockwall, TX (US); Eli Tamez, Rockwall, TX (US)

(72) Inventors: Crystal Tamez, Rockwall, TX (US); Eli Tamez, Rockwall, TX (US)

(21) Appl. No.: 15/934,903

(22) Filed: Mar. 23, 2018

Related U.S. Application Data
(60) Provisional application No. 62/476,433, filed on Mar. 24, 2017.

(51) Int. Cl. B62B 5/08

(52) U.S. Cl. CPC B62B 5/087; A63C 17/02

(57) ABSTRACT

A carriage-apparatus; the carriage-apparatus includes a board-body, a first wheel-unit, a second wheel-unit, rod and an attachment-clamp. In a preferred embodiment, the rod is adjustable via telescopic means. The attachment-clamp is configured to attach the carriage-apparatus to a conventional shopping-cart. The carriage apparatus is useful for providing a safe, convenient, and entertaining way for parents to watch their children while shopping in stores.

### CROSS REFERENCE TO RELATED APPLICATION

The present application is related to and claims priority to U.S. Provisional Patent Application No. 62/476,433 filed Mar. 24, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of shopping carts and more specifically relates to a child-carrier board for removable attachment to shopping carts.

### 2. Description of Related Art

Shopping carts are widely used in supermarkets, department stores, airports and the like. In conventional nestable carts, a foldable child seat is often added to the rear panel of the basket. In one common arrangement for such a foldable seat, the back support panel of the seat is pivotally attached to the chassis near the bottom of the rear basket panel. A fold down seat panel then traverses the back support panel and the rear basket panel to form a child seat inside the basket near the upper portion of the rear basket panel. Unfortunately, these seats are not meant for children over the age of two, leaving parents struggling to push the cart while holding onto their child's or—even more difficult—children's hands. Additionally, parents can easily lose sight of their children when turning around to grab an item from a shelf, leaving parents to frantically search around the store for their missing little ones. A suitable solution is desired.

U.S. Pat. No. 3,834,726 to M. Hobza relates to a standing occupant propelled merchandise carrier. The described standing occupant propelled merchandise carrier includes forward container portion, wheel means supporting the forward container portion, handle means at the rear of the forward container portion and adapted to be gripped by a standing operator, an operator's riding platform having wheels under it and pivotally attached at its forward end to the forward portion whereby an operator riding on the platform can steer the forward portion, the rearward platform being suitable for propulsion in the manner of a scooter.

### BRIEF SUMMARY OF THE INVENTION

In view of the foregoing disadvantages inherent in the known shopping cart art, the present disclosure provides a novel shopping cart attachment. The general purpose of the present disclosure, which will be described subsequently in greater detail, is to provide a safe, convenient, and entertaining way for parents to keep their children close whilst shopping.

A carriage-apparatus is disclosed herein. The carriage-apparatus includes a board-body which may include an elongated-profile being defined by a top-surface, a bottom-surface opposite the top-surface and relative to a floor-surface, a first board-end and a second board-end opposite the first board-end. The elongated-profile may be sized to receive at least one foot of a user. In a preferred embodiment, the elongated-profile may be sized to receive both feet of the user.

A first wheel-unit may be fixedly attached to the bottom-surface of the board-body about the first board-end and include a first at least one wheel able to rotate about a first axle. Similarly, a second wheel-unit may be fixedly attached to the bottom of the surface of the board-body about the second board-end and include a second at least one wheel able to rotate on a second axle. The first wheel-unit and the second wheel-unit may be configured to provide rollability to the board-body along the floor-surface.

Further, a rod may be provided may include a first rod-end, a second rod-end opposite the first rod-end and a rod-length therebetween. The first rod-end may be attached to one of the first board-end and the second board-end of the board-body. In addition to this, an attachment-clamp may be attached to the second rod-end and configured for attachment to the shopping-cart.

A method of using carriage-apparatus is also disclosed herein. The method of using the carriage-apparatus may comprise the steps of: a providing the carriage-apparatus as above; attaching the carriage-apparatus to the shopping-cart via the attachment-clamp; placing the at least one foot of the user on the top-surface of the body-board; and rolling along the floor-surface alongside the shopping-cart.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a shopping cart attachment, constructed and operative according to the teachings of the present disclosure.

FIG. 1 is a side perspective view of the carriage-apparatus during an ‘in-use’ condition, according to an embodiment of the disclosure.

FIG. 2 is a top and side perspective view of the carriage-apparatus of FIG. 1, according to an embodiment of the present disclosure.

FIG. 3 is a top perspective view of the carriage-apparatus of FIG. 1, according to an embodiment of the present disclosure.

FIG. 4 is a side-rear perspective view of the carriage-apparatus of FIG. 1, according to an embodiment of the present disclosure.

FIG. 5 is a side perspective view of the carriage-apparatus of FIG. 1, according to an embodiment of the present disclosure.

FIG. 6 is a flow diagram illustrating a method of use for the carriage-apparatus, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a shopping cart and more particularly to a shopping cart attachment as used to improve the child-carrier board for attachment to shopping carts.

Generally, an apparatus is disclosed which may allow children to ride alongside their parents when shopping with a cart. It helps parents keep a close eye on their children's whereabouts, preventing children from wandering off. It entertains children, adverting tantrums. This saves parents a considerable amount of time, frustration, and panic in stores. The present invention adjusts as needed to accommodate virtually any shopping cart.

The apparatus may include a modified skateboard that may attach to a traditional shopping cart. The skateboard may have a telescopic bar on the front with rotatable joints at the top and bottom to adjust the bar to any length. The rotatable joint at the top may include a clamp with a twist knob to secure the skateboard to the back of a shopping cart. The bottom joint may allow the bar to fold down when not in use.

When attached to the back of a shopping cart, the skateboard may drag behind the left or right wheel, allowing parents to walk behind the cart with their child to either side. The skateboard may be offered in a wide range of colors to appeal to children. The exact specifications may vary upon manufacturing.

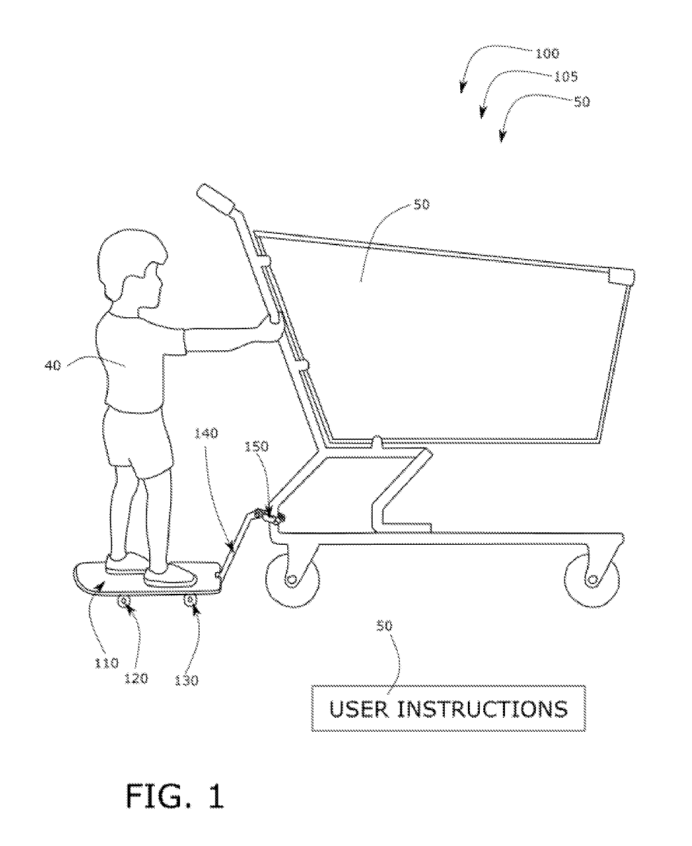

Referring now more specifically to the drawings by numerals of reference, there is shown in FIGS. 1-5, various views of a carriage-apparatus 100.

FIG. 1 shows a carriage-apparatus 100 during an ‘in-use’ condition 150, according to an embodiment of the present disclosure. As illustrated, the carriage-apparatus 100 may include a board-body 110, a first wheel-unit 120, a second wheel-unit 130, a rod 140 and an attachment-clamp 150. As shown, the carriage-apparatus 100 may be configured for attachment to a shopping-cart 5 and sized to receive at least one foot of a user 40. In a preferred embodiment, the at least one foot of a user 40 may include both feet of the user 40. Further, in the preferred embodiment, the user 40 may be a child.

According to one embodiment, the carriage-apparatus 100 may be arranged as a kit 105. The kit 105 may include set of user instructions 107. The instructions 107 may detail functional relationships in relation to the structure of the carriage-apparatus 100 (such that the carriage-apparatus 100 can be used, maintained, or the like, in a preferred manner).

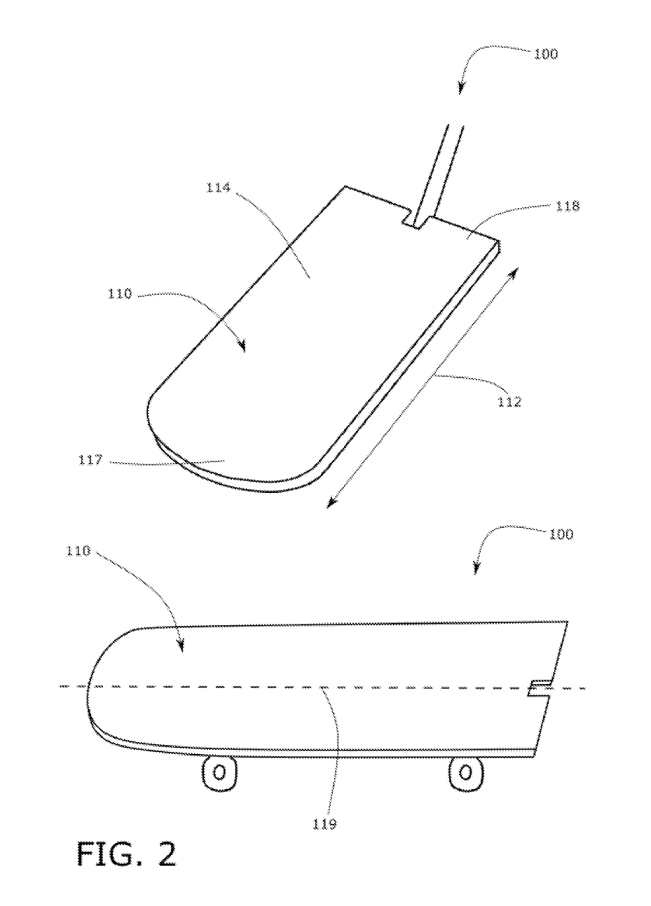

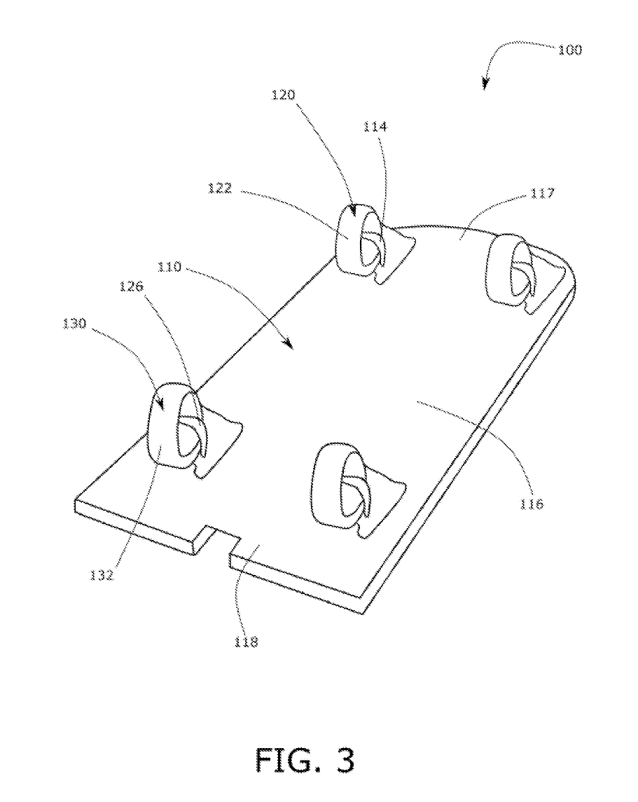

FIG. 2 shows a front perspective view of the carriage-apparatus 100 of FIG. 1, according to an embodiment of the present disclosure. The board-body 110 may include an elongated-profile 112 being defined by a top-surface 114, a bottom-surface 116 (FIG. 3) opposite the top-surface 114 and relative to a floor-surface, a first board-end 117 and a second board-end 118 opposite the first board-end 117. The elongated-profile 112 may be sized to receive the at least one foot of the user 40 as shown in FIG. 1. Further, the elongated-profile 112 may include a horizontal-axis 119 relative to the floor-surface such that the first board-end 117 may be at a left-end of the board-body 110 relative to the horizontal-axis 119, and the second board-end 118 may be at a right-end of the board-body 110 relative to the horizontal-axis 119.

The board-body 110 may be made from wood. In particular, the wood may be maplewood. In addition to this, the maplewood board may be coated with polyurethane on the top-surface 114 of the board-body 110 to provide durability to the board. However, it should be appreciated that other materials are contemplated. For example, the board-body 110 may be made from plastic. The top-surface 114 of the board-body 110 may further include a grip-means such a grip-tape to provide better grip-ability for the user. In some embodiments, the top-surface 114 of the board-body 110 may further include decorative-features such as designs, logos, colors, etc. Other materials may be used.

FIG. 3 shows a front perspective view of the carriage-apparatus 100 of FIG. 1, according to an embodiment of the present disclosure. As shown here, the first wheel-unit 120 may be fixedly attached to the bottom-surface 116 of the board-body 110 about the first board-end 117 and may include a first at least one wheel 122 able to rotate about a first axle 124. Other suitable means for providing rotatability of wheel 122 and wheel 132 may be used. In the preferred embodiment, the first at least one wheel 122 may comprise a first two-wheels. Similarly, the second wheel-unit 130 may be fixedly attached to the bottom of the surface of the board-body 110 about the second board-end 118 and may include a second at least one wheel 132 able to rotate on a second axle 126. In the preferred embodiment also, the second at least one wheel 132 may comprise a second two-wheels. Those with ordinary skill in the art will now appreciate that upon reading this specification and by their understanding the art of wheels and axles and attachment to devices allowing wheels to rotate as described herein, methods of providing such movement will be understood by those knowledgeable in such art.

The first wheel-unit 120 and the second wheel-unit 130 may be configured to provide rollability to the board-body 110 along the floor-surface such that the user 40 is able to ride alongside the shopping-cart 5 (FIG. 1). The user 40 may actuate the rollability manually using their feet, or the first wheel-unit 120 and the second wheel-unit 130 may be rolled via movement of the shopping-cart 5 (FIG. 1).

The first at least one wheel 122 and the second at least one wheel 132 may be made of polyurethane to aid in the rollability of the first wheel-unit 120 and the second wheel-unit 130. The first at least one wheel 122 and the second at least one wheel 132 may be manufactured in a variety of sizes to provide different rollability outcomes. For example, the first at least one wheel 122 and the second at least one wheel 132 may include a diameter of between 55-85 mm to provide a faster rollability. In another example, the first at least one wheel 122 and the second at least one wheel 132 may include the diameter of between 48-54 mm to provide better response time and require less force to roll or accelerate.

Further, the first at least one wheel 122 and the second at least one wheel 132 may be manufactured including a variety of different hardness levels. For example, the at least one wheel and the second at least one wheel 132 may include a softness of as low as Shore A 75 to provide a slower, and therefore safer rolling speed. In another example, the first at least one wheel 122 and the second at least one wheel 132 may include a hardness as high as Shore A 101 to provide a faster rolling speed.

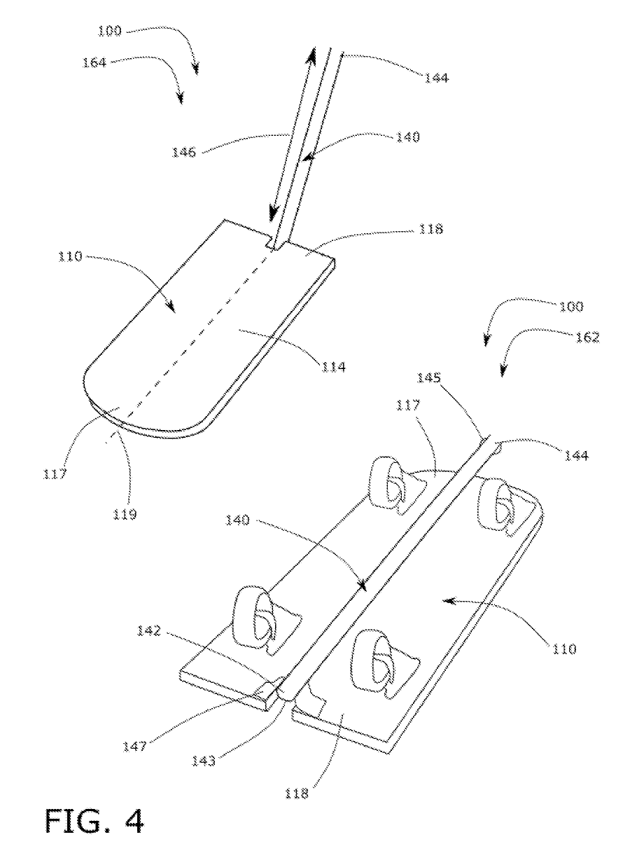

FIG. 4 shows a front perspective view of the carriage-apparatus 100 of FIG. 1, according to an embodiment of the present disclosure. The rod 140 may include a first rod-end 142, a second rod-end 144 opposite the first rod-end 142 and a rod-length 146 therebetween. As shown, the first rod-end 142 may be attached to one of the first board-end 117 and the second board-end 118 of the board-body 110 (shown here to be the second board-end 118). In the preferred embodiment, the rod-length 146 may be adjustable. To achieve this, the rod may be a telescopic rod.

Further, first rod-end 142 may include a first rotatable-joint 143 and the first rod-end 142 may be pivotally-attached to the one of the first board-end 117 and the second board-end 118 of the board-body 110 via the first rotatable-joint 143 (again, shown here to be the second board-end 118). Likewise, the second rod-end 144 may include a second rotatable-joint 145.

The first rotatable-joint 143 may allow the rod to be foldable and pivot-able into different orientations. In this embodiment, the rod may include a folded-position 162 and an extended-position 164; the extended-position 164 including the rod-length 146 being substantially diagonal to the horizontal-axis 119. The substantially diagonal orientation of the extended-position 164 may be moveable into varying degrees of diagonal. Further, the folded-position 162 may include the rod-length 146 being parallel to the horizontal-axis 119 and locked to one of the top-surface 114 and the bottom-surface 116 of the board-body 110. The first rod-end 142 may also include a locking-means 147 configured to lock the rod in the folded-position 162.

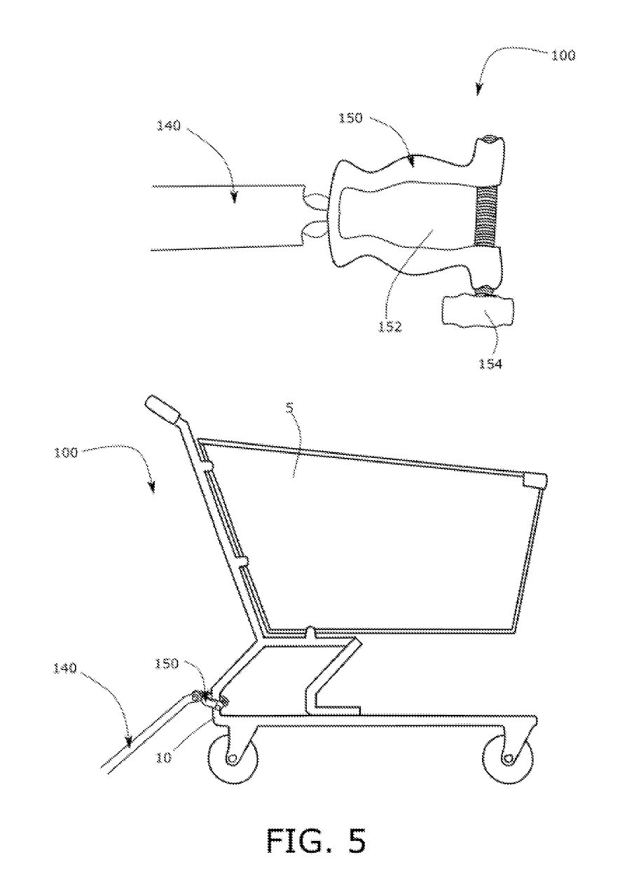

FIG. 5 shows a front perspective view of the carriage-apparatus 100 of FIG. 1, according to an embodiment of the present disclosure. As shown here, the attachment-clamp 150 may be attached to the second rod-end 144 and configured for attachment to the shopping-cart 5. In the preferred embodiment, conventional shopping-carts 5 may be utilized. Such shopping-carts 5 may comprise a plurality of vertical support-posts 10 and each of the plurality of vertical support-posts 10 may include a thickness. As such, in the preferred embodiment, the attachment-clamp 150 may include a clamp-opening 152 sized to receive the thickness of one of the plurality of vertical support-posts 10.

Further to this, the attachment-clamp 150 may include an adjustable-knob 154 configured to adjust a size of the clamp-opening 152 such that the attachment-clamp 150 is able to fasten to any sized shopping-cart 5. The adjustable-knob 154 may also allow the user 40 to tighten the attachment-clamp 150 onto the shopping-cart 5 to prevent the carriage-apparatus 100 from coming loose. To remove, the user 40 may then unscrew the adjustable-knob 154 to loosen. The attachment-clamp 150 may be made of a combination of stainless steel and iron to provide durability and to prevent decay or degradation of the attachment-clamp 150.

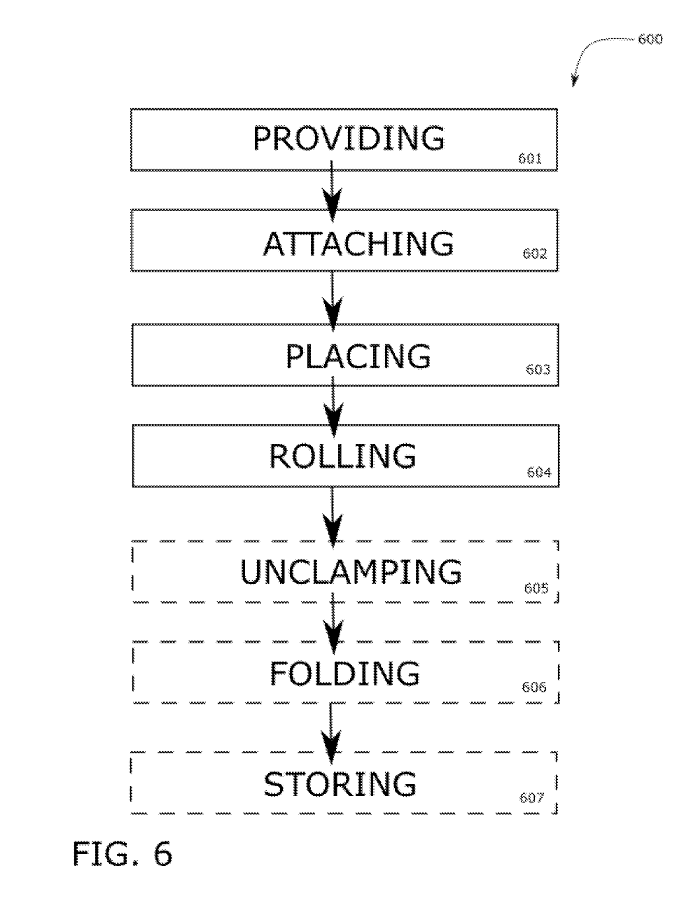

FIG. 6 is a flow diagram illustrating a method of using a carriage-apparatus for attachment to a shopping-cart 600, according to an embodiment of the present disclosure. As illustrated, the method of using a carriage-apparatus for attachment to a shopping-cart 600 may include the steps of: step one 601, providing the carriage-apparatus 100 as above; step two 602, attaching the carriage-apparatus 100 to the shopping-cart 5 via the attachment-clamp 150; step three 603, placing the at least one foot of the user 40 on the top-surface 114 of the body-board (in the preferred embodiment, the at least one foot of a user 40 may include both feet of the user 40); and step four 604, rolling along the floor-surface alongside the shopping-cart 5. Further steps may include: step five 605, un-clamping the carriage-apparatus 100 from the shopping-cart 5; step six 606, folding the rod 140 into a folded-position 162; and step seven 607, storing the carriage-apparatus 100.

It should be noted that step five 605, step six 606 and step seven 607 are optional steps and may not be implemented in all cases. Optional steps of method of use 600 are illustrated using dotted lines in FIG. 6 so as to distinguish them from the other steps of method of use 600. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for carriage-apparatus 100 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A carriage-apparatus for attachment to a shopping-cart, the apparatus comprising:
a board-body including an elongated-profile being defined by a top-surface, a bottom-surface opposite the top-surface and relative to a floor-surface, a first board-end and a second board-end opposite the first board-end, and wherein the elongated-profile is sized to receive at least one foot of a user;
a first wheel-unit fixedly attached to the bottom-surface of the board-body about the first board-end, the first wheel-unit including a first at least one wheel able to rotate about a first axle;
a second wheel-unit fixedly attached to the bottom of the surface of the board-body about the second board-end, the second wheel-unit including a second at least one wheel able to rotate on a second axle, and wherein the first wheel-unit and the second wheel-unit are configured to provide rollability to the board-body along the floor-surface;
a rod including a first rod-end, a second rod-end opposite the first rod-end and a rod-length therebetween, and wherein the first rod-end is attached to one of the first board-end and the second board-end of the board-body; and
an attachment-clamp attached to the second rod-end, and wherein the attachment-clamp is configured for attachment to the shopping-cart.

2. The carriage-apparatus of claim 1, wherein the rod-length is adjustable.

3. The carriage-apparatus of claim 3, wherein the rod is a telescopic rod.

4. The carriage-apparatus of claim 1, wherein the first rod-end includes a first rotatable-joint.

5. The carriage-apparatus of claim 1, wherein the second rod-end includes a second rotatable-joint.

6. The carriage-apparatus of claim 5, wherein the first rod-end is pivotally-attached to the one of the first board-end and the second board-end of the board-body via the first rotatable-joint.

7. The carriage-apparatus of claim 6, wherein the rod is foldable and includes a folded-position and an extended-position.

8. The carriage-apparatus of claim 7, wherein the first rod-end includes a locking-means configured to lock the rod in the folded-position.

9. The carriage-apparatus of claim 1, wherein the elongated-profile includes a horizontal-axis relative to the floor-surface.

10. The carriage-apparatus of claim 9, wherein the folded-position includes the rod-length being parallel to the horizontal-axis.

11. The carriage-apparatus of claim 10, wherein the folded-position includes the rod-length being locked to one of the top-surface and the bottom-surface of the board-body.

12. The carriage-apparatus of claim 10, wherein the extended-position includes the rod-length being substantially diagonal to the horizontal-axis.

13. The carriage-apparatus of claim 1, wherein the shopping-cart comprises a plurality of vertical support-posts, each of the plurality of vertical support-posts including a thickness, and wherein the attachment-clamp includes a clamp-opening sized to receive the thickness of one of the plurality of vertical support-posts.

14. The carriage-apparatus of claim 13, wherein the attachment-clamp includes an adjustable-knob configured to adjust a size of the clamp-opening.

15. The carriage-apparatus of claim 1, wherein the first at least one wheel comprises a first two-wheels.

16. The carriage-apparatus of claim 1, wherein the second at least one wheel comprises a second two-wheels.

17. A carriage-apparatus for attachment to a shopping-cart, the apparatus comprising:
a board-body including an elongated-profile being defined by a top-surface, a bottom-surface opposite the top-surface and relative to a floor-surface, a first board-end and a second board-end opposite the first board-end, and wherein the elongated-profile is sized to receive at least one foot of a user;
a first wheel-unit fixedly attached to the bottom-surface of the board-body about the first board-end, the first wheel-unit including a first at least one wheel able to rotate on a first-axle;
a second wheel-unit fixedly attached to the bottom of the surface of the board-body about the second board-end, the second wheel-unit including a second at least one wheel able to rotate on a second axle, and wherein the first wheel-unit and the second wheel-unit are configured to provide rollability to the board-body along the floor-surface;
a rod including a first rod-end, a second rod-end opposite the first rod-end and a rod-length therebetween, and wherein the first rod-end is attached to one of the first board-end and the second board-end of the board-body; and
an attachment-clamp attached to the second rod-end, and wherein the attachment-clamp is configured for attachment to the shopping-cart;
wherein the rod-length is adjustable;
wherein the rod is a telescopic rod;
wherein the first rod-end includes a first rotatable-joint;
wherein the second rod-end includes a second rotatable-joint;
wherein the first rod-end is pivotally-attached to the one of the first board-end and the second board-end of the board-body via the first rotatable-joint;
wherein the rod is foldable and includes a folded-position and an extended-position;
wherein the first rod-end includes a locking-means configured to lock the rod in the folded-position;
wherein the elongated-profile includes a horizontal-axis relative to the floor-surface;
wherein the folded-position includes the rod-length being parallel to the horizontal-axis;
wherein the folded-position includes the rod-length being locked to one of the top-surface and the bottom-surface of the board-body;
wherein the extended-position includes the rod-length being substantially diagonal to the horizontal-axis;
wherein the shopping-cart comprises a plurality of vertical support-posts, each of the plurality of vertical support-posts including a thickness, and
wherein the attachment-clamp includes a clamp-opening sized to receive the thickness of one of the plurality of vertical support-posts;
wherein the attachment-clamp includes an adjustable-knob configured to adjust a size of the clamp-opening;
wherein the first at least one wheel comprises a first two-wheels; and
wherein the second at least one wheel comprises a second two-wheels.

18. The carriage-apparatus of claim 17, further comprising set of instructions; and
wherein the carriage-apparatus is arranged as a kit.

19. A method of using a carriage-apparatus for attachment to a shopping-cart, the method comprising the steps of:
providing the carriage-apparatus for attachment to the shopping-cart, the carriage-apparatus including:
a board-body including an elongated-profile being defined by a top-surface, a bottom-surface opposite the top-surface and relative to a floor-surface, a first board-end and a second board-end opposite the first board-end, and wherein the elongated-profile is sized to receive at least one foot of a user;
a first wheel-unit fixedly attached to the bottom-surface of the board-body about the first board-end, the first wheel-unit including a first at least one wheel about to rotate on a first axle;
a second wheel-unit fixedly attached to the bottom of the surface of the board-body about the second board-end, the second wheel-unit including a second at least one wheel about to rotate on a second axle, and wherein the first wheel-unit and the second wheel-unit are configured to provide rollability to the board-body along the floor-surface;
a rod including a first rod-end, a second rod-end opposite the first rod-end and a rod-length therebetween, and wherein the first rod-end is attached to one of the first board-end and the second board-end of the board-body; and
an attachment-clamp attached to the second rod-end, and wherein the attachment-clamp is configured for attachment to the shopping-cart;
attaching the carriage-apparatus to the shopping-cart via the attachment-clamp;
placing the at least one foot of the user on the top-surface of the body-board; and
rolling along the floor-surface alongside the shopping-cart.

20. The method of claim 19, further comprising the steps of:
un-clamping the carriage-apparatus from the shopping-cart;
folding the rod into a folded-position; and
storing the carriage-apparatus.
